(19) United States
(12) Patent Application Publication
(10) Pub. No.: US 2007/0154015 A1
(43) Pub. Date: Jul. 5, 2007

(54) Method for cipher key conversion in wireless communication

(75) Inventors: Paul Anthony Polakos, Marlboro, NJ (US); Anil Rana, Morganville, NJ (US)

Correspondence Address: MARK W. SINCELL;Williams, Morgan & Amerson, P.C., Suite 1100, 10333 Richmond, Houston, TX, 77042, US

(73) Assignee: Lucent Technologies

(21) Appl. No.: 11/321,896

(22) Filed: Dec. 29, 2005

(51) Int. Cl. H04K 1/00

(52) U.S. Cl. 380/255

(57) ABSTRACT

The present invention provides a method for authenticating a mobile unit in a wireless communication system. The method includes accessing information indicative of a random number and of a first key formed using a first cryptographic function. The method also includes forming second and third keys based on the random number, on the first key, and on second and third cryptographic functions that are different than the first cryptographic function. The method further includes transmitting data encrypted using the second and third keys over an air interface.

### BACKGROUND OF THE INVENTION

1. Field of the Invention

This invention relates generally to communication systems, and, more particularly, to wireless communication systems.

2. Description of the Related Art

In a typical Second Generation (2G) wireless communication system; base station routers may be used to provide wireless connectivity to one or more mobile units. Exemplary mobile units include cellular telephones, personal data assistants, smart phones, text messaging devices, wireless interface cards, notebook computers, desktop computers, and the like. Security for cellular networks has evolved rapidly in recent years, in large part due to the increasing customer demand for wireless services, such as voice communication, data communication, and multimedia services like video telephony. Cryptographic digital authentication may be implemented in digital communication systems, such as 2G wireless communication systems, to protect service providers from the fraudulent use of their networks and to provide user privacy.

Mobile units that initiate communications in a secure network environment are authenticated by the network and then communication between the base station routers and the mobile units may be encrypted using one or more cipher keys. For example, in a 2G wireless communication system, a mobile unit may send a Page Response Message to a base station controller, which may forward the Page Response Message to a mobile switching center (MSC). In response to the Page Response Message, the mobile switching center may send a request for authentication data to a home location register (HLR), which stores information associated with the mobile unit including a pre-provisioned ciphering key, Ki. The home location register generates a random number (RAND) and the keys XRES and Kc using the random number (RAND), the ciphering key Ki, and the standard cryptographic functions a3 and a8. The home location register then returns the random number RAND and the keys XRES and Kc to the mobile switching center, e.g., in an Authentication Data Response. The random number RAND and the keys XRES and Kc may be referred to collectively as a “triplet.”

The second-generation mobile switching center forwards the random number RAND to the base station controller, e.g., in an Authentication Request message, and the base station controller passes this message to the mobile unit. The mobile unit may then use the random number RAND, a pre-provisioned copy of the ciphering key Ki, and the standard cryptographic functions a3 and a8 to generate the keys RES and Kc. The mobile unit provides the key RES to the mobile switching center, which then compares the keys XRES and RES provided by the home location register and the mobile unit, respectively. If the XRES and RES keys match, then the mobile unit is authenticated to the network. Once the mobile unit has been authenticated, the mobile unit and the base station may communicate by transmitting data encrypted using copies of the cipher key Kc, which are present at both the mobile unit and the base station.

Second generation wireless communication systems and networks are being replaced by wireless communication systems and networks that operate in accordance with third generation (3G) wireless communication standards, such as the wireless communication standards for Universal Mobile Telecommunication System (UMTS) defined by the Third Generation Partnership Project (3GPP) and the wireless communication standards for CDMA defined by the Third Generation Partnership Project—2 (3GPP2). Third generation wireless communication standards require use of the mutually authenticated Authentication and Key Agreement (AKA) security protocol. For example, a third generation mobile switching center may send a request for authentication data to a home location register (HLR) in response to a Page Response Message from the third generation base station router. The home location register generates a random number (RAND), the XRES key, a cipher key CK, an integrity key IK, and an authentication token AUTN using the random number (RAND), the ciphering key Ki, and the standard cryptographic functions f2, f3, and f4. The home location register then returns the random number RAND, the keys XRES, CK, and IK, and the authentication token AUTN to the mobile switching center, e.g., in an Authentication Data Response. The random number RAND, the keys XRES, CK, and IK, and the authentication token AUTN may be referred to collectively as a “quintet.”

The third generation mobile switching center forwards the random number RAND to the base station router, e.g., in an Authentication Request message, and the base station router passes this message to the mobile unit. The mobile unit may then use the random number RAND, the pre-provisioned ciphering key Ki, and the standard cryptographic functions f2, f3, and f4 to generate the keys RES, CK, and IK. The mobile unit provides the key RES to the mobile switching center, which then compares the keys XRES and RES provided by the home location register and the mobile unit, respectively. If the XRES and RES keys match, then the mobile unit is authenticated to the network. Once the mobile unit has been authenticated, the mobile unit and the base station router may communicate by transmitting data encrypted using copies of the keys CK and IK, which are present at both the mobile unit and the base station router.

In practice, service providers typically deploy communication systems that include a mixture of second generation and third generation components, at least in part because of the enormous expense of completely upgrading a 2G infrastructure to a 3G infrastructure. For example, a service provider may wish take advantage of the functionality in third generation base station routers, but may not wish to upgrade previously purchased second generation infrastructure, such as second generation mobile switching centers. However, mobile units may not be able to form secure connections with hybrid second and third generation communication systems. For example, as discussed above, a third generation mobile unit will generate the keys CK and IK, and use these keys to encrypt and/or decrypt communication with a base station router. However, a second-generation mobile switching center will provide the cipher key Kc to the base station router for encryption and/or decryption. Consequently, the keys used to encrypt and/or decrypt information exchanged between a third generation mobile unit and a base station router will not be compatible when the base station router is coupled to a second generation mobile switching center.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for authenticating a mobile unit in a wireless communication system. The method includes accessing information indicative of a random number and of a first key formed using a first cryptographic function. The method also includes forming second and third keys based on the random number, on the first key, and on second and third cryptographic functions that are different than the first cryptographic function. The method further includes transmitting data encrypted using the second and third keys over an air interface.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a wireless communication system, in accordance with the present invention; and

FIG. 2 conceptually illustrates one exemplary embodiment of a method of authenticating a mobile unit in a wireless communication system, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software-implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

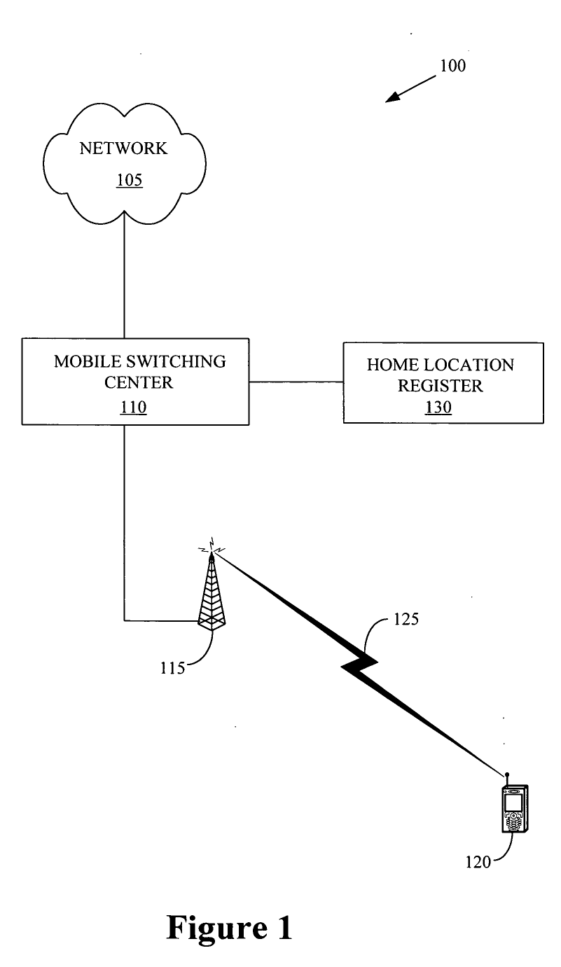

FIG. 1 conceptually illustrates one exemplary embodiment of a wireless communication system 100. In the illustrated embodiment, the wireless communication system 100 operates according to Universal Mobile Telecommunication System (UMTS) protocols. However, persons of ordinary skill in the art having benefit of the present disclosure should appreciate that the wireless communication system 100 may operate according to any protocol or combination of protocols. For example, the wireless communication system 100 may alternatively operate according to a Global System for Mobile communication (GSM) protocol. The wireless communication system 100 includes a network 105, which may include wired and/or wireless portions that operate according to any wired and/or wireless protocols. For example, the network 105 may be a public Internet.

A mobile switching center 110 is communicatively coupled to the network 105. In the illustrated embodiment, the mobile switching center 110 is a second generation (2G) mobile switching center 110. However, persons of ordinary skill in the art having benefit of the present disclosure should appreciate that the mobile switching center 110 may not necessarily be a second generation mobile switching center 110. The mobile switching center 110 is communicatively coupled to a base station router 115, which may provide wireless connectivity to one or more mobile units 120 over an air interface 125. The mobile units 120 may also be referred to using terms such as “user equipment,” “access terminal,” “mobile terminal,” and the like. Techniques for operating the mobile switching center 110, the base station router 115, and the mobile units 120 are known in the art and, in the interest of clarity, only those aspects of operation of the mobile switching center 110, the base station router 115, and/or the mobile units 120 that are relevant to the present invention will be discussed further herein.

The mobile unit 120 may be authenticated by the communication system 100. In the illustrated embodiment, the mobile switching center 110 may access information provided by a home location register 130 to authenticate the mobile unit 120. For example, as will be discussed in detail below, the mobile unit 120 and the home location register 130 may respectively form response (RES) and expected response (XRES) keys using standard a3 and/or f2 cryptographic functions. The RES and XRES keys may be provided to the mobile switching center 110, which may compare the RES and XRES keys to authenticate the mobile unit 120.

Once the mobile unit 120 has been authenticated, the base station router 115 and a mobile unit 120 may exchange encrypted information over the air interface 125. However, in the illustrated embodiment, the mobile unit 120 implements a different authentication scheme than the mobile switching center 110 and/or the home location register 130. For example, the mobile switching center 110 and/or the home location register 130 may implement a second generation (2G) authentication scheme and the mobile unit 120 may implement a third-generation (3G) authentication scheme, such as the AKA scheme. Accordingly, the ciphering keys formed by the home location register 130 and the mobile unit 120 may be different, at least in part because the two authentication schemes use different cryptographic functions to form the ciphering keys. For example, the home location register 130 may form a Kc ciphering key using the standard a8 cryptographic function, but the mobile unit 120 may form a cipher key CK and an integrity key IK using the standard a8 and f4 cryptographic functions, respectively.

The base station router 115 may use the cipher key formed by the home location register 130 to form cipher keys that correspond to the cipher keys formed by the mobile units 120. In one embodiment, the base station router 115 may form a cipher key CK and an integrity key IK using the standard f3 and f4 cryptographic functions, respectively, as well as the Kc cipher key provided by the home location register 130. The cipher key CK and the integrity key IK formed by the base station router 115 may then correspond to the cipher key CK and the integrity key IK formed by the mobile unit 120. The base station router 115 and the mobile unit 120 may then use the cipher key CK and/or the integrity key IK to encrypt and/or decrypt information transmitted and/or received over the air interface 125. For example, the base station router 115 may encrypt data and transmit the encrypted data over the air interface 125 to the mobile unit 120, which may then decrypt the encrypted data. For another example, the mobile unit 120 may encrypt data and transmit the encrypted data over the air interface 125 to the base station router 115, which may then decrypt the encrypted data.

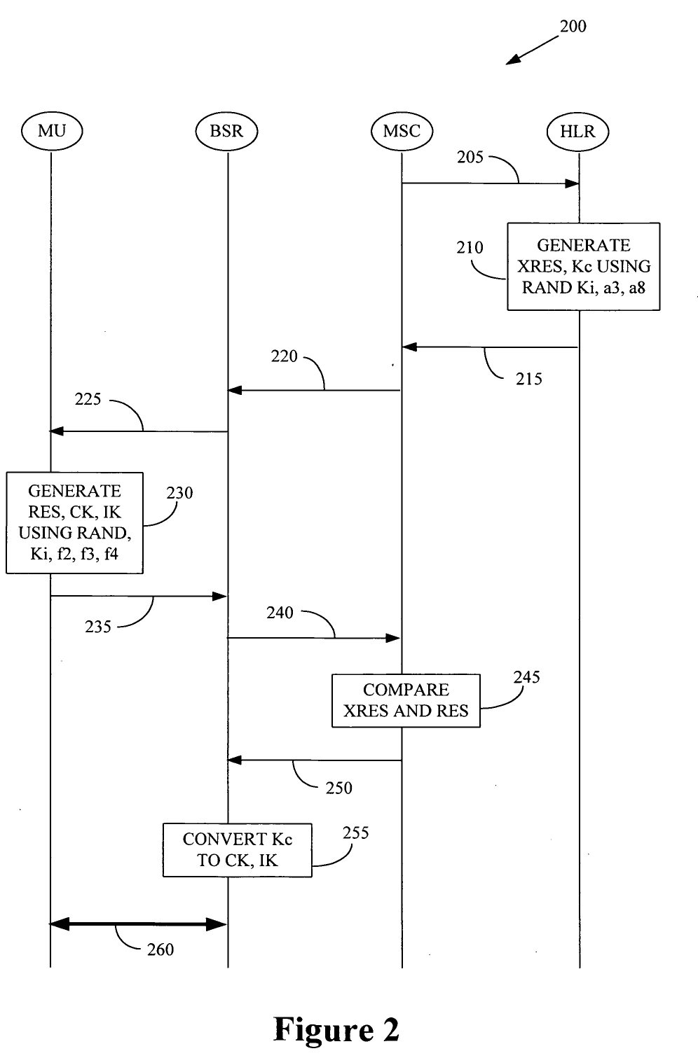

FIG. 2 conceptually illustrates one exemplary embodiment of a method 200 of authenticating a mobile unit (MU). In the illustrated embodiment, a mobile switching center (MSC) provides an authentication data request to a home location register (HLR), as indicated by the arrow 205. For example, the mobile switching center may provide the authentication data request to the home location register in response to a request from the mobile unit to initiate a call session. The home location register may then generate (at 210) a random number RAND in response to receiving the authentication data request 205. The home location register may also generate (at 210) an XRES key and a Kc cipher key using the random number RAND, a pre-provisioned key Ki, and one or more cryptographic functions, such as the standard a3 and a8 cryptographic functions. The home location register provides the random number RAND, the XRES key, and the Kc cipher key to the mobile switching center, e.g., in an authentication data response, as indicated by the arrow 215.

The mobile switching center may then provide the random number RAND to a base station router (BSR), e.g., in an authentication request, as indicated by the arrow 220. The base station router may then provide the random number RAND to the mobile unit over an air interface, as indicated by the arrow 225. In response to receiving a message including a random number RAND, the mobile unit may generate (at 230) one or more keys. For example, the mobile unit may generate (at 230) a RES key, a cipher key CK, and an integrity key IK using the random number RAND, a pre-provisioned key Ki, and one or more cryptographic functions such as the standard f2, f3, and f4 cryptographic functions. The mobile unit may then provide one of the keys, such as the RES key, to the base station router over the air interface, as indicated by the arrow 235. The base station router may then provide a message, such as an authentication response, including the RES key to the mobile switching center as indicated by the arrow 240.

The mobile switching center may then compare (at 245) the keys provided by the home location register and the mobile unit, e.g., the XRES and RES keys. If the provided keys do not match, then the mobile switching center may determine that the mobile unit should not be authenticated. However, if the provided keys match, then the mobile switching center may authenticate the mobile unit and provide another key, such as the Kc cipher key, to the base station router in a message such as a ciphering mode command, as indicated by the arrow 250. The base station router may then convert (at 255) the key provided by the mobile switching center into one or more keys to correspond to keys formed by the mobile unit. In one embodiment, the base station router converts (at 255) the Kc cipher key provided by the home location register into a cipher key CK and an integrity key IK using the Kc cipher key and the standard f3 and f4 cryptographic functions. The base station router and the mobile unit may then exchange encrypted information over the air interface using their respective copies of the cipher key CK and the integrity key IK, as indicated by the arrow 260.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
accessing information indicative of a random number and of a first key formed using a first cryptographic function;
forming second and third keys based on the random number, on the first key, and on second and third cryptographic functions that are different than the first cryptographic function; and
transmitting data encrypted using the second and third keys over an air interface.

2. The method of claim 1, wherein accessing the information comprises accessing information provided by a home location register that is indicative of the random number and of the first key.

3. The method of claim 2, wherein accessing information indicative of the first key comprises accessing information indicative of a first key formed by the home location register using a standard a8 cryptographic function.

4. The method of claim 2, wherein accessing the information comprises receiving at least one of an authentication request and a ciphering mode command from a mobile switching center.

5. The method of claim 4, wherein receiving the information comprises receiving information indicative of the random number in the authentication request.

6. The method of claim 4, wherein receiving the information comprises receiving information indicative of the first key in the ciphering mode command.

7. The method of claim 1, comprising providing information indicative of the random number over the air interface.

8. The method of claim 7, comprising receiving a fourth key in response to providing the information indicative of the random number, the fourth key being formed by a mobile unit using the random number, a pre-provisioned key, and a fourth cryptographic function.

9. The method of claim 8, wherein receiving the fourth key comprises receiving a fourth key formed using a standard f2 cryptographic function.

10. The method of claim 8, comprising providing the fourth key to the mobile switching center.

11. The method of claim 10, comprising receiving an authentication signal in response to providing the fourth key to the mobile switching center, wherein the authentication signal indicates a result of the mobile switching center comparing the fourth key to a fifth key formed using the fourth cryptographic function and provided by the home location register, thereby to authenticate the mobile unit.

12. The method of claim 11, wherein forming the second and third keys comprises forming the second and third keys in response to receiving information indicating that the mobile unit is authenticated.

13. The method of claim 12, wherein forming the second and third keys comprises forming the second and third keys using standard f3 and f4 cryptographic functions, respectively.

14. The method of claim 1, comprising decrypting information received over the air interface using the second and third keys.
